(19) United States
(12) Patent Application Publication
(10) Pub. No.: US 2024/0172815 A1
(43) Pub. Date: May 30, 2024

(54) Bra Cup and Method of Manufacturing Thereof

(71) Applicant: Antonio De Micco Padula, Rome (IT)

(72) Inventor: Antonio De Micco Padula, Rome (IT)

(21) Appl. No.: 17/994,269

(22) Filed: Nov. 25, 2022

(51) Int. Cl. A41C 3/12; A41C 5/00

(52) U.S. Cl. CPC A41C 3/12; A41C 5/005

(57) ABSTRACT

A bra cup manufactured using flexible foam particles. The manufacturing method comprises batching, cutting and sanitizing flexible foam particles. The flexible foam particles are blended together with a reactive material to form a mixture. The mixture may be cured to provide a bra cup of a substantially uniform structure in a desired shape and density. Using flexible polyurethane foam particles in the process of making bra cups, a reduced amount of virgin flexible polyurethane foam is required to manufacture brassieres.

### CROSS REFERENCE TO RELATED APPLICATIONS

Not Applicable

### BACKGROUND OF THE INVENTION

The present invention relates to a brassiere. More particularly the invention relates to a bra cup manufactured using flexible foam particles and a method of manufacturing the same.

Foams have numerous applications in a wide range of every day products. Foams may be open-celled or closed-celled, and are usually classified as flexible, semi-flexible, semi-rigid, or rigid. Flexible foams are generally foams that recover after deformation, such as automobile seating, mattresses, soft toys and soft furnishings. Rigid foams are generally foams that do not recover after deformation, such as foams used for packaging, insulation and helmet padding. Examples of foams include polyurethane, polystyrene, polyester, silicone, and latex foams.

Foams may also be used in apparel products. Brassiere and swimwear pads, also known as “bra cups”, are generally made with flexible foams, such as polyurethane or latex foams for example. Conventionally, bra cups are manufactured using virgin flexible polyurethane foams and later incorporated into bras or other articles of clothing, such as brassieres and swimsuits for example. The term “virgin polyurethane flexible foam” is used to describe a new polyurethane flexible foam that has not been processed in any manner other than cutting to shape.

Flexible polyurethane foams have historically resisted recycling or recovering efforts as their chemical composition makes these foams hazardous during thermal decomposition. Generally, recovering or recycling options of flexible polyurethane foams are limited to mechanical shredding and chemical processing that normally result in relatively high density or hard products with limited practical uses. Because of this, a primary use for mechanically recycled or recovered flexible polyurethane foam, such as rebond foam for example, is generally in carpeting, automotive and furniture applications with moderate to high impact usages. Because of this, virgin polyurethane flexible foam is normally used in the manufacturing of low density, soft and flexible polyurethane products.

Bra cups are typically made of virgin flexible foams. In known bra cups manufacturing methods, a virgin flexible polyurethane foam is manufactured in the conventional method in a basic shape such as a cuboid or other hexahedron. Further, the solid virgin flexible polyurethane foam is then placed in a mold and compressed into a desired bra cup shape. Because a bra cup is formed using a compression molding process at temperatures typically higher than 180° C., virgin flexible polyurethane foam designed to mold at high temperatures is normally used to form a bra cup. In other known art, injection molding of a liquid foam formulation may be used to make a bra cup. Using this method, a liquid polyurethane formulation is injected in a mold at a certain pressure. Once in the mold, the polyurethane liquid fills the mold cavity and it cures in a desired bra cup shape. Because such process starts in liquid form, in known methods virgin foam formulations are used to make a bra cup.

Flexible polyurethane foam bra cups are a fundamental element of a brassiere or swimsuit to provide a soft and comfortable fit to the wearer while maintaining the necessary shape, flexibility, and other physical properties required to support a woman's breasts. However, recycled or recovered flexible polyurethane foams, such as rebond foam for example, may have inferior physical properties, irregular or high densities and hardness, and uneven or imperfect finishes. Because a bra cup is formed using a compression molding process at temperatures typically higher than 180° C., known rebond foam is not suitable for making bra cups. Because flexible foams recyclate may be polluted or may contain bacteria, fungal spores, and allergens, such as dust mites for example, a bra cup manufactured using flexible foam recyclate may not be suitable to be in contact with a wearer's body. Because of this, in known methods only virgin flexible foam is used to manufacture foam bra cups.

Bra cups are generally made with a fabric or cloth bonded to a foam as the bra cup is worn in contact with a wearer's body. Because flexible polyurethane foam recycling methods are normally limited to foam only waste or scrap, manufacturing of bra cups typically produces waste or scrap destined to landfills. Because bra cups are normally attached to the rest of a brassiere or garment, which may also include other materials, such as plastic and ferrous accessories, a bra underwire for example, it is normally not possible to recycle or recover a bra cup unless it becomes detached from the rest of the garment. Because a bra cup cannot be practically recycled or recovered, normally bra cups end up in landfills at their end of life.

Because bra cups are generally made of virgin flexible foams and they cannot ordinarily be recycled, bra cups have normally a higher impact to the environment than recovered, recycled or recyclable products.

### BRIEF SUMMARY OF THE INVENTION

In a first aspect of the invention a method of manufacturing a bra is provided, comprising the steps (a) batching a flexible foam, (b) cutting the flexible foam into particles, (c) sanitizing the flexible foam, (d) blending the particles with a reactive material to form a mixture, (e) placing the mixture into a mold to allow the mixture to turn into a solid within the mold, and (f) curing the mixture in the mold at a set mold temperature to form the solid.

According to one embodiment of the invention, the method may further comprise steps to remove polluting materials from the foam. In one embodiment of the invention, the method may further comprise a cleaning process, such as washing the flexible foam with a water and detergent solution for example. Preferably radio-frequency thermal processing equipment may be used for sanitizing the flexible foam.

In one embodiment of the invention, the flexible foam particles may be a polyurethane foam cut into particles of dimensions preferably smaller than or equal to 110 mm and likely larger than 0.001 mm. Preferably a reactive material may be an adhesive, more preferably a polyurethane prepolymer, and even more preferably a hot melt polyurethane adhesive. Another preferable reactive material may be a polyol at least, and more preferably a liquid blend of a polyol and isocyanate at least.

In one embodiment of the invention, the method may comprise preheating the mold prior to the placing. In one embodiment, the method may comprise chilling the mold during the curing. In one embodiment of the method, the mold is shaped to form a bra cup. In another embodiment of the method, the mold is shaped into a solid to be further shaped into a bra cup. In a preferable embodiment of the invention, the method is enhanced by coating the foam particles at a desired high temperature with a hot polyurethane reactive material. In this method the mixture cures from a hot temperature to a cooler temperature in a mold, resulting in a final product of a desired low density and soft hand feel. In a more preferable embodiment of the invention, the method may comprise flexible foam particles blended with a liquid reactive material, such as a liquid polyol at least or a liquid blend of polyol and isocyanate for example, and cured into a solid. In this method the liquid blend may be cured from a liquid into a solid encompassing the flexible foam particles, resulting in a desired substantially uniform structure.

In one embodiment of the invention, the method may provide a bra cup with substantially uniform density within the bra cup. In a preferable embodiment of the invention, the method may provide a bra cup with desired variable density within the bra cup to provide anticipated functional regions within the bra cup.

A second aspect the present invention comprises a bra cup for incorporation with other components to form a padded brassiere, said bra cup formed by bonding flexible foam particles into a solid structure comprising flexible foam particles, and a reactive material. Preferably the flexible foam particles comprise polyurethane foam. Preferably the reactive material is a polyurethane adhesive. Preferably the reactive material is a polyurethane prepolymer. Preferably the reactive material is a low melt polyester material. Even more preferably, the reactive material is a hot melt polyurethane adhesive. Said bra cup may further comprise a layer of material attached to the outer part of the bra cup. Said bra cup may further comprise a layer of material attached to the inner part of the bra cup.

A third aspect of the present invention comprises a bra cup formed by blending flexible foam particles into a solid structure comprising a first material, and a second material comprising flexible foam particles. Further, the second material may be embedded within the first material. Preferably the first material comprises a polyurethane flexible foam. Preferably the flexible foam particles comprise polyurethane foam. Preferably the first material and the second material are formed in contact with each other. Preferably the first material and the second material form a substantially uniform structure. Preferably a bra cup may further comprise a layer of material attached to the outer part of the bra cup. Preferably a bra cup may further comprise a layer of material attached to the inner part of the bra cup.

The invention will be explained in further detail in conjunction with drawings representing various embodiments. In the drawings and in the following descriptions further characteristics and advantages associated with the invention are evident.

### BRIEF DESCRIPTION OF THE DRAWINGS

FIGS. 1A, FIG. 1B and FIG. 1C illustrate a first exemplary embodiment of a bra cup formed by bonding flexible foam particles together.

FIGS. 2A, FIG. 2B and FIG. 2C illustrate a second exemplary embodiment of a bra cup formed by flexible foam particles embedded within a solid material.

FIGS. 3A and 3B illustrate a third exemplary embodiment of a bra cup formed by bonding flexible foam particles together and attached to a first solid material and to a second solid material.

FIG. 4A, FIGS. 4B and 4C illustrate a fourth exemplary embodiment of a bra cup formed by flexible foam particles embedded within a first solid material attached to a second solid material.

FIG. 5 is an exemplary method for preparing foam particles for the manufacturing of a bra cup.

FIG. 6 is an exemplary method for manufacturing a bra cup using flexible foam particles bonded together.

FIG. 7 is an exemplary method for manufacturing a bra cup using flexible foam particles embedded within a solid material.

### DETAILED DESCRIPTION OF THE INVENTION

The present invention provides bra cups manufactured using flexible foam particles and a method of manufacturing thereof. The present invention is described in enabling detail in the following examples, which may represent more than one embodiment of the present invention.

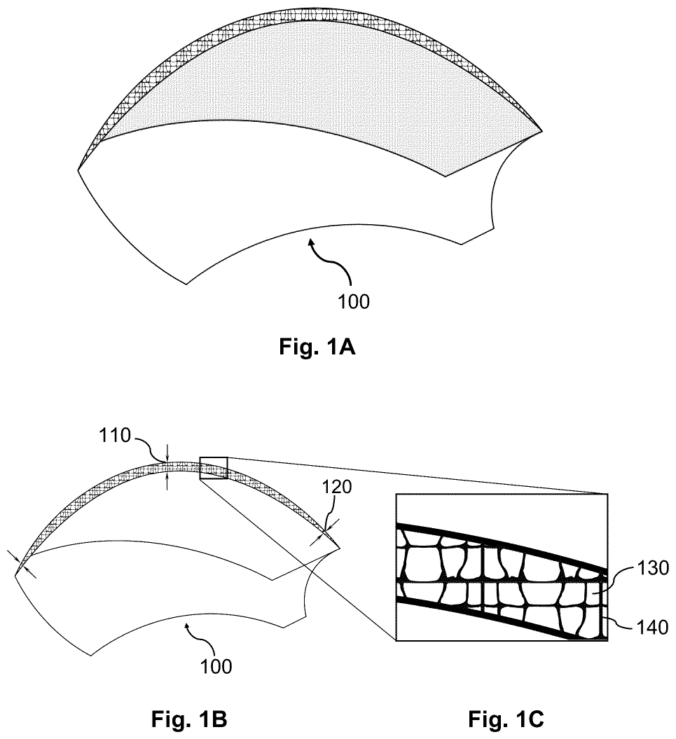

FIGS. 1A, FIG. 1B and FIG. 1C illustrate a first exemplary bra cup 100 according to an embodiment of the present invention. In this example, a cross-sectional view of bra cup 100 is shown in FIG. 1A. As shown in FIG. 1B, the cross section of bra cup 100 may be formed with a first region 110 of a substantially constant thickness in the bust point area of bra cup 100 and with a second region 120 of a desired decreasing thickness towards the edges of bra cup 100. As shown in FIG. 1C, bra cup 100 of FIG. 1A may comprise flexible foam particles 130 of a desired size, for example ranging from 4 mm to 8 mm in size. In this example, flexible foam particles 130 may be bonded together with a reactive material, such as a polyurethane adhesive for example. The reactive material may form a glue line 140 able to hold the flexible foam particles 130 together into a single solid flexible structure. Because the foam particles located in region 110 may be only slightly compressed according to an embodiment of the present invention, a resulting exemplary bra cup 100 may provide a desired lower density and soft hand feel in region 110. Because the foam particles located in section 120 may be more compressed, a resulting bra cup 100 may provide a higher density towards the edges of the bra cup in region 120. Because of this, a resulting exemplary bra cup 100 may have a desired level of support in region 120 and may provide a comfortable coverage in the bust point area region 110.

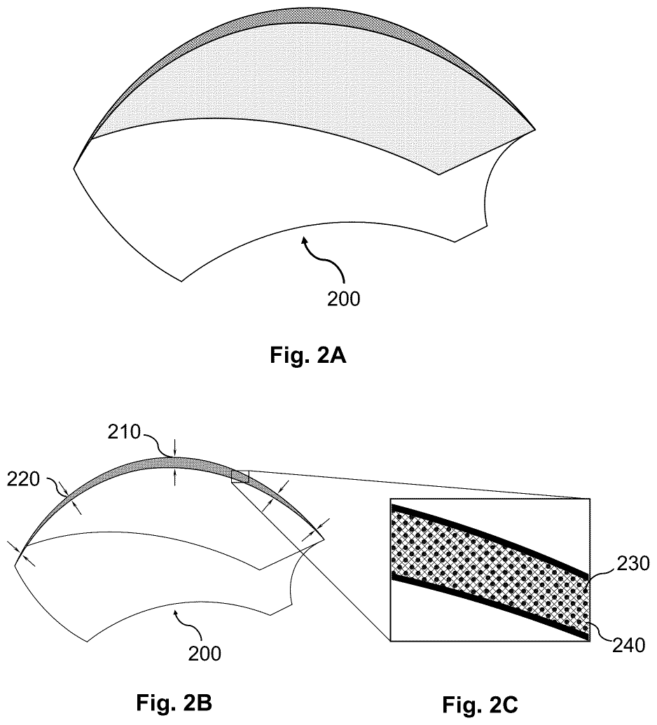

FIGS. 2A, FIG. 2B and FIG. 2C illustrate a second exemplary bra cup 200 according to an embodiment of the present invention. In this example, a cross-sectional view of bra cup 200 is shown in FIG. 2A. As shown in FIG. 2B, the cross section of bra cup 200 may be formed with a relatively thick first region 210 in the bust point area of bra cup 200 and a second region 220 thinning towards the edges in the peripheral area of bra cup 200. As shown in FIG. 2C, bra cup 200 of FIG. 2A may comprise flexible foam particles 230 of a desired size, for example less than 2 mm and likely larger than 0.001 mm. The flexible foam particles 230 may be embedded within a solid material 240, such as a virgin polyurethane flexible foam for example.

Because according to an embodiment of the present invention the solid structure 240 may be cured from a liquid into a solid encompassing flexible foam particles 230, the resulting exemplary bra cup 200 may be formed in one solid flexible structure of substantially uniform density and hardness. Because according to an embodiment of the present invention an exemplary bra cup 200 may be formed into a solid from a liquid mixture comprising flexible foam particles, only flexible foam particles 230 smaller or equal to the thickness dimensions of region 210 and region 220 may be embedded within the solid structure 240 at any given point of an exemplary bra cup 200. Because of this, the resulting bra cup 200 may comprise flexible foam particles in their uncompressed original state. The resulting bra cup 200 may provide a desired lower density and soft hand feel substantially uniform throughout.

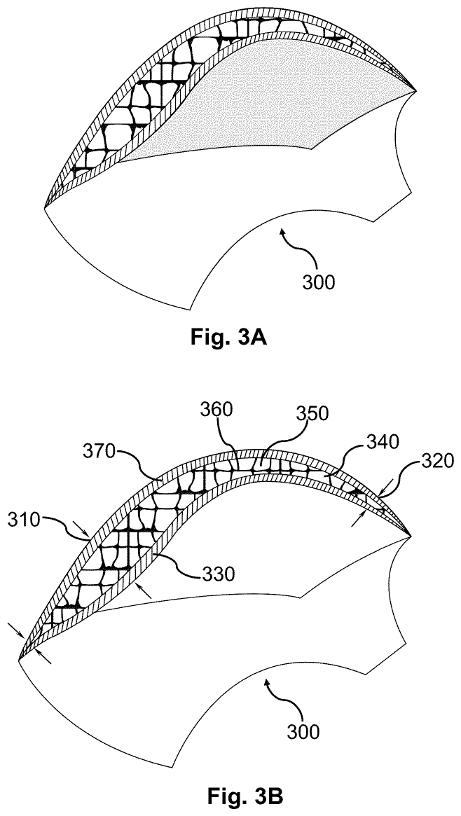

FIGS. 3A and 3B illustrate a third exemplary bra cup 300 according to an embodiment of the present invention. In this example, a cross-sectional view of bra cup 300 is shown in FIG. 3A. As shown in FIG. 3B, the cross section of bra cup 300 may be formed with a first region 310 comprising a thicker functional push-up portion disposed at a bottom area of a bra cup 300 and positioned inside of a bra cup 300. Further, bra cup 300 may comprise a second region 320 comprising a thinning cross section in a non-functional area of bra cup 300. As shown in FIG. 3B, bra cup 300 of FIG. 3A may comprise three components. A first component 330 may be placed on the inside area of a bra cup 300. Component 330 may comprise a solid structure, such as a virgin flexible solid foam bonded to a cloth for example, of a desired thickness. A second component 340 may be placed in the middle area of a bra cup 300. Component 340 may comprise flexible foam particles 350. In this example, flexible foam particles 350 may be bonded together with a reactive material, such as a polyurethane adhesive for example. The reactive material may form a glue line 360 able to hold the flexible foam particles 350 together in one solid flexible structure. A third component 370 may be placed on the outer area of a bra cup 300. Component 370 may comprise a solid, such as a virgin flexible solid foam bonded to a cloth for example, of a desired thickness. In one embodiment, component 340 may be bonded with component 330 and with component 370 to form together a single solid structure of bra cup 300. According to an embodiment of this invention, the resulting bra cup 300 may provide an anticipated push-up effect with a desired low density and soft hand feel.

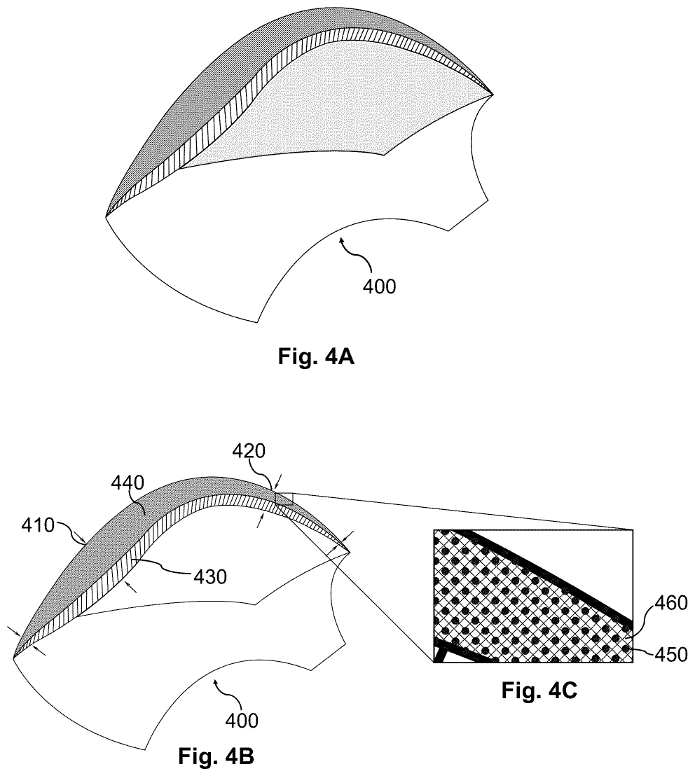

FIG. 4A, FIGS. 4B and 4C illustrate a fourth exemplary bra cup 400 according to an embodiment of the present invention. In this example, a cross-sectional view of bra cup 400 is shown in FIG. 4A. As shown in FIG. 4B, the cross section of bra cup 400 may be formed with a first region 410 comprising a thicker functional push-up portion disposed at a bottom area of a bra cup 400 and positioned inside of a bra cup 400. Further, bra cup 400 may comprise a second region 420 comprising a thinning cross section in a non-functional area of bra cup 400. As shown in FIG. 4B, bra cup 400 of FIG. 4A may comprise two components. A first component 430 may be placed on the inside area of a bra cup 400. Component 430 may comprise a solid structure, such as a virgin flexible solid foam bonded to a cloth for example, of a desired thickness. A second component 440 may be placed in the outer area of a bra cup 400. As shown in FIG. 4C, component 440 may comprise flexible foam particles 450 of a desired size, for example less than 2 mm and likely larger than 0.001 mm. In this example, the flexible foam particles 450 may be embedded within a solid material 460, such as a virgin polyurethane flexible foam for example. Because according to an embodiment of the present invention a solid material 460 may be cured from a liquid into a solid encompassing flexible foam particles 450, the resulting exemplary component 440 may be formed in one solid flexible structure of substantially uniform density and hardness. In one embodiment, component 440 may be bonded with component 430 to form together a single solid structure of bra cup 400. According to an embodiment of this invention, the resulting bra cup 400 may provide an anticipated push-up effect with a desired low density and soft hand feel substantially constant throughout.

Though exemplary bra cups are illustrated above, other bra cup types with thicker or thinner functional areas and thicker or thinner nonfunctional areas are possible according to the present invention described herein. Examples of such additional functional types of bra cups include, but are not limited to, creating full coverage shapes, manufacturing impact absorbing bra cups, or producing brassieres providing extra support and shaping along the underarm.

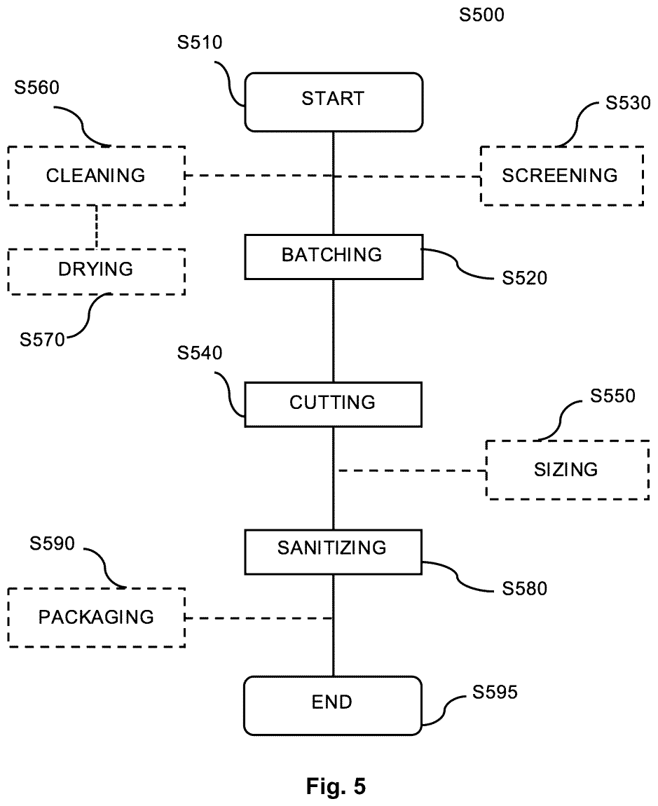

FIG. 5 illustrates an exemplary method S500 of preparing flexible foam particles for the manufacturing of a bra cup according to the present invention.

At step S510, the method S500 begins.

At step S520, batching of a flexible foam recyclate occurs. The term recyclate is used to describe a material or materials intended to be recovered or processed into a newly formed material or product. Because the present invention may be used to recover every flexible foam recyclate in general, it may be preferable to group a plurality of foams recyclate together into a batch according to at least one desired foam property that may be suitable for an intended bra cup. An exemplary batch may comprise a plurality of flexible foams with different densities in a white color. Another exemplary batch may comprise a plurality of dark color foams grouped by varying density ranges. A preferable batch may comprise a plurality of flexible foams with similar colors and with densities less than or equal to 160 kg/m³ and likely greater than 8 kg/m³. A more preferable batch may comprise an open-celled flexible polyurethane foam with a substantially uniform color and with a density less than or equal to 80 kg/m³ and likely greater than 15 kg/m³. An even more preferable batch may comprise a flexible foam recyclate of uniform color and even density.

At step S530, which may occur optionally at any time before step S520, a screening process may optionally occur. Because a preferred bra cup may be required to be free of polluting material, a flexible foam recyclate may go through a screening process, such as a metal detecting process used to detect the presence of ferrous materials, for example. In a preferred method, a flexible foam recyclate found to be contaminated with polluting material may be separated, discarded or reprocessed from step S510.

At step S540, a cutting process occurs. Because the present invention may be used in general to recover a flexible foam recyclate of any dimension, it may be preferable to cut the flexible foam recyclate into pieces of desired dimensions in order to form a batch comprising flexible foam particles of substantially uniform dimensions. A preferred method may use a known cutting machine, for example a chopper or a shredder, to cut a flexible foam recyclate into flexible foam particles with desired dimensions. The shredded foam may be of any dimension which is compatible with the equipment available. However, preferably the flexible foam recyclate is shredded into flexible foam particles having dimensions of from about 2 mm to about 110 mm, and more preferably of from about 4 mm to about 50 mm, and even more preferably of from about 6 mm to about 12 mm. A more preferable method may use a known mechanical grinder to grind a flexible foam recyclate into a powder. An even more preferable method may use a cryogenic grinding process to pulverize a flexible foam recyclate. The ground flexible foam particles may be of any dimension which is compatible with the equipment available. A preferred ground flexible foam particles recyclate may comprise flexible foam particles with dimensions of less than 2 mm, preferably of less than 0.25 mm, and likely of larger than 0.001 mm.

At step S550, sizing may optionally occur. In a preferred method flexible foam particles recyclate may be screened to remove particles of irregular or undesired dimensions. In an exemplary method flexible foam particles may be sifted through a screen to select flexible foam particles with dimensions of less than 2 mm, for example. Another exemplary method may remove flexible foam particles with dimensions of from about 6 mm to about 12 mm. In a preferred method a batch may be sifted through a moving screen, such as a vibrating, rotating, oscillating or revolving screen, comprising of a desired mesh size. In a preferred method, flexible foam particles not conforming to desired dimensions may be grouped into a separate batch, or returned to step S540, or discarded.

At step S560, which may occur optionally at any time before step S520, a cleaning process may optionally occur. Because a foam recyclate may be contaminated with impurities, dirt, or other polluting materials, cleaning of a foam recyclate may occur. In a preferred method, a washing process may be used to clean the foam recyclate. An exemplary washing method may include a conveyor belt carrying a foam recyclate to a water bath comprised of an aqueous based cleaning solution. Further the foam recyclate may be transferred through a squeeze conveyor type to a rinse type water bath. Another exemplary washing method may use a conventional rotary washing machine. In a more preferable method steaming may be used to clean flexible foam particles. An exemplary steaming method may include placing flexible foam particles in a rotary chamber. While the flexible foam particles rotate in the chamber, steam comprising water at least, which may include additives such as a detergent for example, may be sprayed onto the flexible foam particles.

At step S570, a drying process may optionally occur. Because a wet flexible foam recyclate may be resistant to drying at room temperature, in a preferred method drying of a flexible foam recyclate may occur after cleaning at step S560. In an exemplary method a flexible foam recyclate may be dried using conventional driers, such as a heated oven or a tumble dryer. Because flexible foams in general tend to discolor when exposed to heat, in a preferred method a flexible foam recyclate may be dried using a radio-frequency thermal dryer.

At step S580, sanitizing occurs. Because a flexible foam recyclate may contain bacteria, fungal spores, and allergens, such as dust mites for example, in a preferred method a flexible foam recyclate may be sanitized. In an exemplary method, a flexible foam recyclate may be placed in a desired known ultraviolet (“UV”) chamber where the sanitization process may occur. Because flexible foams in general tend to discolor when exposed to high heat or ultraviolet rays typically used in sanitization processes, in a preferred method according to the present invention a flexible foam recyclate may be sanitized using a radio-frequency thermal equipment. Because the heat generation in a radio-frequency thermal processing machine may be used to allow a process for bacteria inactivation, and dust-mites removal for example, in a preferred method flexible foam particles may be placed in a conveyor type radio-frequency thermal processing machine for a desired time and machine settings determined suitable to sanitize the flexible foam particles. The resulting flexible foam particles may be sanitized with suitable or no discoloration according to the present invention.

At step S590, packaging may optionally occur. Because a flexible foam particles recyclate may be stored before further processing, in a preferred method a packaging process may occur to avoid contamination during storage. In an exemplary method a flexible foam particles recyclate may be processed through a mechanical baler and packed into a desired bale size. In a preferred method a flexible foam particles recyclate may be stored in a container in a temperature and humidity controlled manner. In an even more preferable method a flexible foam particles recyclate may be stored in an airtight container.

At step S595, the method S500 ends.

Foam particles prepared according to method S500 above may be suitable to blend or mix with a reactive material to form a bra cup according to the present invention. Exemplary methods of the invention are described in enabling detail in the following examples, which may represent more than one embodiment of the present invention.

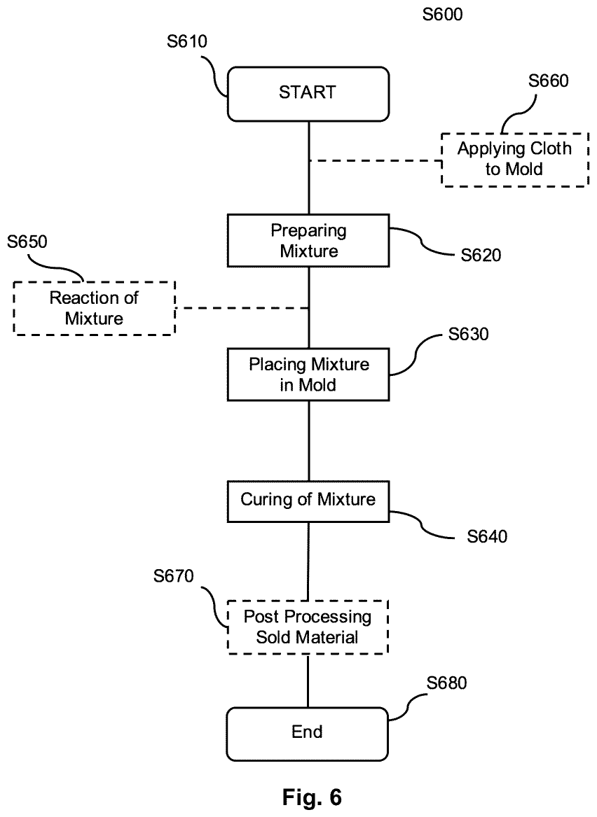

FIG. 6 illustrates an exemplary method S600 of manufacturing a bra using flexible foam particles bonded together according to the present invention.

At step S610, the method S600 begins.

At step S620, a reactive material is added to flexible foam particles. In a preferred method according to the present invention, a weighted amount of flexible foam particles prepared according to method S500 above may be combined with a reactive material to form a mixture. A reactive material may be a binder able to react and cure into a solid. The term binder is used to describe a material intended to hold or draw flexible foam particles together to form a cohesive whole mechanically, chemically, by adhesion or cohesion. A binder may be a polyurethane adhesive or a solvent-based adhesive for example. An exemplary binder may be a low melt polyester fiber able to react at a desired temperature likely greater than 110° C. Another exemplary binder may be a polyurethane prepolymer which may be able to react with air or water at least. A preferred binder may be a hot melt polyurethane adhesive. In a preferred method for making a mixture, a binder may be added to flexible foam particles to uniformly mix or coat the flexible foam particles. In an exemplary method for making a mixture, a binder may be mixed or sprayed on flexible foam particles while the flexible foam particles are rotated in a blender. In a more preferable method, the flexible foam particles are placed in a heated chamber. Hot dry air is introduced in the heated chamber to retain the flexible foam particles suspended in the air for a desired period of time. During such time, a hot melt polyurethane binder for example is introduced in the heated chamber to substantially coat the flexible foam particles. In a similar method a low melt polyester material may be introduced in the heated chamber to mix with the flexible foam particles.

In a preferred method for making a mixture, flexible foam particles may be coated with a binder by placing the flexible foam particles in a gap between two close parallel pressing cylinders or conveyors rotating or moving in the same or opposite direction, and rotating or moving at different speeds. Some or all cylinders and conveyors may be treated in such a way as to increase friction with the foam particles, by means of surface lining or knurling for example. Some or all cylinders and conveyors may be treated or coated in such a way as to be able to be wetted or impregnated with a binder. Some or all cylinders and conveyors may be treated or coated in such a way as to be able to be heated or chilled. Some or all cylinders and conveyors may be treated or coated in such a way as to be able to operate at desired temperatures suitable for a desired binder. The friction between the wetted or impregnated cylinders or conveyors and the flexible foam particles may allow the flexible foam particles to be coated with the binder while turning between the rollers or conveyors to create a mixture. In such a preferred method for making a mixture, a desired partial number of rollers or conveyors may be wetted or impregnated with a prepolymer based adhesive at room temperature, and a remaining number of rollers may be wetted or impregnated with water at room temperature, which may comprise additives, such as a catalyst for example, to coat the foam particles during turning.

In the above preferred method, a desirable binder may comprise a hot melt adhesive, such as hot melt polyurethane adhesive for example. Because a hot melt adhesive may be formulated with desirable viscosities at desired temperatures, the rollers or conveyors may be heated to a desired temperature and wetted or impregnated with a hot melt adhesive to coat the surface of the foam particles during turning. Because it may be desirable to control the cooling process of a hot melt adhesive, some or all the rollers or conveyors may be chilled to a desired temperature suitable to bring a mixture to a desired state. Because a hot melt adhesive, such as hot melt polyurethane adhesive for example, may be able to provide a soft and uniform structure, a mixture according to the present invention may be able to provide a desired bra cup with relatively low hardness and low densities.

At step S630, a mixture is placed in a mold. Because a reactive material may require additional steps or time to cure, a mixture is placed in a desired mold to cure. An exemplary mold may be of a desired shape such as a cuboid, or a cylinder, or other hexahedron. Because a preferred mixture may comprise hot melt polyurethane adhesive, a preferable mold may be preheated to avoid thermal shock or unintended curing. A preferred mold may be preheated at a temperature of from about 20° C. to about 200° C. A more preferable mold may be preheated at a temperature of from about 80° C. to about 120° C. Because the present invention may provide a smooth or seamless solid block of a desired density, a resulting solid foam block may be suitable to be further converted or transformed into a desired bra cup. Because the mixture may comprise a hot melt polyurethane adhesive or a low melt polyester material, the resulting solid foam block may be converted or transformed into a desired bra cup using compression molding or thermoforming methods in the conventional art. However, because the mixture may be in a cohesive whole not yet cured into a solid when placed in a mold, a preferable mold may be of a desired bra cup shape. Because the mixture may directly cure into a solid with a desired shape of a bra cup, the resulting bra cup from the present invention is not under the constraints discussed above with respect to the compression molding of foam blocks in the conventional art. The resulting bra cup may not have a tendency to deform, and may have a desired shape and density throughout.

At step S640, curing of a mixture occurs. Because a mixture is cured into a bra cup or foam block from an agglomerate of particles not yet formed into a solid, the curing process may occur either in a closed mold or an open mold. A preferable mold may be set at a temperature in the range of 20° C. to 200° C. A more preferable mold may be set at a temperature in the range of 75° C. to 125° C. Further, the curing process may occur at varying temperatures and durations of time to create a solid bra cup or solid block having a desired density, hardness, flexibility, or other material characteristics drawn to specific application requirements. Because a preferred mixture may comprise hot melt polyurethane adhesive, a preferable mold may be chilled to cure the mixture. Because such a mixture does not require high pressures to become a solid according to the present invention, a resulting bra cup may be of desired soft hand feel and desired low density range. Because a mixture may comprise a reactive material that may be processed at relatively high temperatures, such as a hot melt polyurethane adhesive for example, the resulting solid foam block may be further processed into a bra cup according to the conventional methods.

At step S650, which may occur optionally at any time before step S630, a reaction of a mixture occurs. Generally, the process at step S650 may include any or all preparation steps of a mixture material necessary to place the material in a suitable state for being formed into a solid bra cup or solid foam block. The process itself may include various types of gases and liquids as may be known in the art to place a mixture into a state in which it can be successfully molded into a desired shape. A polyurethane reactive adhesive based mixture may, for example, be reacted with atmosphere or another gaseous mixture approximating or matching the composition of atmosphere. Similarly, a prepolymer based mixture may, for example, be reacted with water only or water with added catalysts or other suitable reagents. Other combinations of mixtures and reactants suitable to use in method S600 specifically, or the method according to this application more generally, may be substituted as is known or may become known.

At step S660, which may occur optionally at any time before step S620, a material may be applied to a mold. An exemplary material may be a cloth or a foam. A preferable material may comprise a cloth previously bonded with a foam. Another exemplary material may be an insert required for a desired bra cup, such as an underwire for example. Such material may be applied in order to bond the material to a molded bra cup during the curing process, occurring at step S640. If the cloth or other material is not applied to the mold prior to the curing process at step S640, the material may be applied, attached, bonded, or otherwise joined at any point after the curing in accordance with the assembly of a garment incorporating the bra cup

At step S670, which may occur optionally at any time after step S640, post-processing of a solid bra cup or a solid block may occur. Here, additional processing including, but not limited to, cutting, peeling, trimming, lamination, bonding, molding, applying a coating to the bra cup for a desired color or to prevent discoloration or other deterioration of the bra cup, removal of flash or other post-manufacturing cleanup, or application of cloth or installation into a garment or product, may be performed.

At step S680, the method S600 ends.

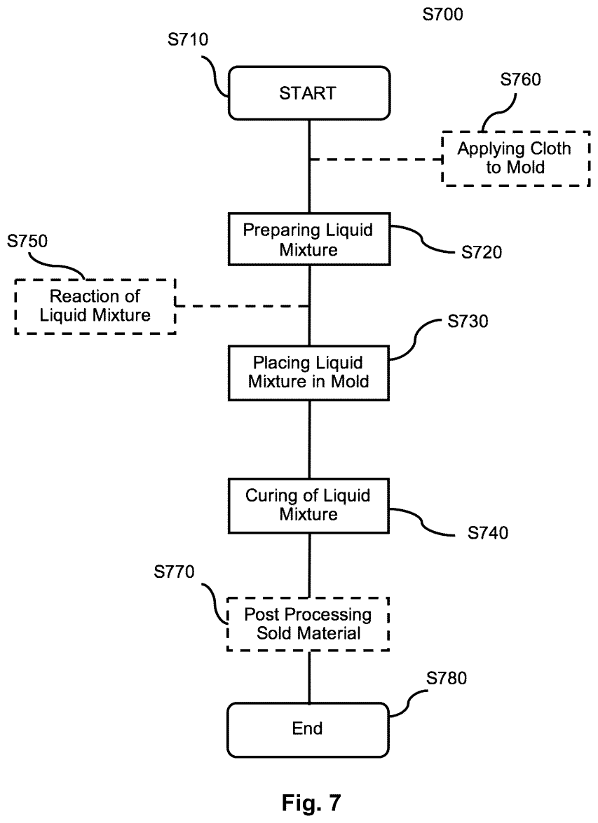

FIG. 7 illustrates an exemplary method S700 of manufacturing a bra using flexible foam particles embedded within a solid material according to the present invention.

At step S710, the method S700 begins.

At step S720, flexible foam particles may be blended with a reactive material. In a preferred method according to the present invention, a weighted amount of flexible foam particles prepared according to method S500 above may be blended with a reactive material to form a mixture. A reactive material may be a liquid material able to react and cure into a solid material. A liquid may be a polyurethane formulation. An exemplary liquid may be a polyurethane prepolymer which may be able to react with air or water at least. A preferred liquid may be a polyol. A more preferable liquid may be a foam forming formulation comprising a polyol and an isocyanate at least. A polyol may be a polyether polyol or a polyester polyol, for example. An isocyanate may be an aromatic diisocyanate, such as toluene diisocyanate (TDI) or methylene diphenyl diisocyanate, (MDI) for example. Additional additives may be added to the liquid such as flame retardants and plasticizers, for example. In an exemplary method for making a mixture, a weighted amount of foam particles may be blended with a liquid using a known mixer. In a preferred method for making a mixture a weighted amount of foam particles may be blended with a liquid polyol to form a slurry. In an even more preferable method, a weighted amount of the flexible foam particles may be mixed together with a polyurethane foam forming formulation in a mixing chamber to form a mixture.

At step S730, a mixture is placed in a mold. In an exemplary method a mixture may be a desired amount of foam forming formulation poured in liquid form into a mold containing a desired amount of flexible foam particles. In a preferred method a mixture prepared according to step S720 above is placed in a mold. A preferred method may comprise a desired amount of flexible foam particles mixed together with a desired amount of polyurethane foam forming formulation to form a mixture according to step S720 above and then placed in a mold. In a more preferable method, a mixture is a slurry comprising a desired amount of flexible foam particles and a desired amount of polyol as prepared in step S720. In such method a desired amount of the polyol slurry is mixed with a desired amount of isocyanate and poured in a mold. An exemplary mold may be of a desired shape such as a cuboid, or a cylinder, or other hexahedron. Because the present invention may provide a smooth or seamless solid foam block of a desired density, the solid foam block may be further converted or transformed into a desired bra cup using compression molding or thermoforming methods in the conventional art. However, because a mixture may be in liquid form when placed in a mold, a preferable mold may be of a desired bra cup shape. A preferable mold may be set at a temperature in the range of 20° C. to 200° C. A more preferable mold may be set at a temperature in the range of 75° C. to 150° C. In this case, a bra cup resulting from the present invention is not under the constraints discussed above with respect to the compression molding of foam blocks in the conventional art because the mixture may directly cure into a solid with a desired shape of a bra cup. The resulting bra cup may not have a tendency to deform, and may have a desired shape throughout.

At step S740, curing of a mixture into a solid having the shape of a bra cup or block defined by the mold occurs. Because a mixture is cured into a solid bra cup or block from a liquid form, the curing process may occur either in a closed mold or an open mold. Further, the curing process may occur at varying temperatures and durations of time to create a solid bra cup or solid block having a desired hardness, flexibility, or other material characteristics drawn to specific application requirements. Because the mixture may be cured from a desired amount of liquid into a solid material, the resulting bra cup may be formed in one solid flexible structure of a preferred density according to a desirable anticipated brassiere.

At step S750, which may occur optionally at any time before step S730, a reaction of a mixture occurs. Generally, the process at step S750 may include any or all preparation steps of a foam particulate or a mixture material necessary to place the material in a suitable state for being formed into a bra cup or block. The process itself may include various types of gases and liquids as may be known in the art to place a mixture into a state in which it can be successfully molded into a desired shape. In a preferred method, a polyol based slurry may be reacted with an isocyanate based material, such as an aromatic diisocyanate, such as toluene diisocyanate (TDI) or methylene diphenyl diisocyanate, (MDI) for example. In a more preferable method, a mixture comprising flexible foam particles and a foam forming formulation may, for example, be reacted with atmosphere or another gaseous mixture approximating or matching the composition of atmosphere. Other combinations of foam particulates or mixtures and reactants suitable to use in method S700 specifically, or the method according to this application more generally, may be substituted as is known or may become known.

At step S760, which may occur optionally at any time before step S720, a material may be applied to a mold. An exemplary material may be a cloth or a foam. A preferable material may comprise a cloth previously bonded with a foam. Another exemplary material may be an insert required for a desired bra cup, such as an underwire for example. Such material may be applied in order to bond the material to a molded bra cup during the curing process, occurring at step S740. If the cloth or other material is not applied to the mold prior to the curing process at step S740, the material may be applied, attached, bonded, or otherwise joined at any point after the curing in accordance with the assembly of a garment incorporating the bra cup

At step S770, which may respectively occur optionally at any time after step S740, post-processing of a solid bra cup or a solid block may occur. Here, additional processing including, but not limited to, cutting, peeling, trimming, lamination, bonding, molding, applying a coating to the bra cup for a desired color or to prevent discoloration or other deterioration of the bra cup, removal of flash or other post-manufacturing cleanup, or application of cloth or installation into a garment or product, may be performed.

At step S780, the method S700 ends.

Though certain specific embodiments and examples are given above with respect to both the exemplary manufacturing methods and the bra cup configurations resulting therefrom, the above descriptions are not to be taken to limit this disclosure to those descriptions. The bra cup and method of manufacturing the same may incorporate additional physical components or processes relating to bras, bra cups, or the manufacture of bras or bra cups, that may be known or may become known, without departing from the spirit and scope of the above disclosure. It will also be apparent to the skilled artisan, that the embodiments described above are specific examples of a single broader invention which may have greater schope than any of the singular descriptions taught. There may be many alterations made in the descriptions without departing from the spirit and scope of the present invention.

What is claimed:

1. A method of manufacturing a bra cup, the method comprising:
a) batching a flexible foam;
b) cutting the flexible foam into particles;
c) sanitizing the flexible foam particles;
d) blending the flexible foam particles with a reactive material to form a mixture;
e) placing the mixture into a mold to allow the mixture to turn into a solid within the mold; and
f) curing the mixture in the mold at a desired temperature to form the solid.

2. The method according to claim 1, further comprising cleaning the flexible foam prior to step (d).

3. The method according to claim 1, further comprising sanitizing the flexible foam with a radio-frequency thermal processing equipment prior to step (d).

4. The method according to claim 1, wherein the flexible foam is a polyurethane foam.

5. The method according to claim 1, wherein the flexible foam particles are of dimensions in the range of 0.001 mm to 110 mm.

6. The method according to claim 1, wherein the reactive material is an adhesive.

7. The method according to claim 1, wherein the reactive material is a polyurethane prepolymer.

8. The method according to claim 1, wherein the reactive material is a hot melt polyurethane adhesive.

9. The method according to claim 1, wherein the reactive material is a low melt polyester material.

10. The method according to claim 1, wherein the reactive material is a polyol at least.

11. The method according to claim 1, wherein the reactive material is a liquid blend comprising a polyol and an isocyanate at least.

12. The method according to claim 1, further comprising reacting the reactive material with a preparing agent.

13. The method according to claim 12, wherein the reactive material is a polyol at least and the reacting agent is an isocyanate at least.

14. The method according to claim 12, wherein the reactive material is a liquid blend comprising a polyol and an isocyanate at least, and the reacting agent is atmosphere at least.

15. The method according to claim 12, wherein the reactive material is polyurethane adhesive, and the reacting agent is atmosphere.

16. The method according to claim 12, wherein the reactive material is a solvent-based adhesive, and the reacting agent is atmosphere.

17. The method according to claim 12, wherein the reactive material is a hot melt polyurethane adhesive, and the reacting agent is atmosphere.

18. The method according to claim 12, wherein the reactive material is a low melt polyester material, and the reacting agent is atmosphere.

19. The method according to claim 12, wherein the reactive material is a polyurethane prepolymer, and the reacting agent is water at least.

20. The method according to claim 1, wherein the mold is shaped to form a solid.

21. The method according to claim 1, wherein the curing further forms a solid of a substantially uniform structure.

22. The method according to claim 21, further comprising shaping the solid into a bra cup.

23. The method according to claim 1, wherein the mold is shaped to form a bra cup.

24. The method according to claim 1, wherein the curing further forms a bra cup of a substantially uniform structure.

25. The method according to claim 1, wherein the curing forms flexible foam particles embedded within a solid material.

26. The method according to claim 25, wherein the solid material is a polyurethane foam.

27. The method according to claim 25, wherein the solid is in the shape of a hexahedron.

28. The method according to claim 25, wherein the solid is in the shape of a cylinder.

29. The method according to claim 25, further comprising shaping the solid into a bra cup.

30. The method according to claim 25, wherein the solid is in the shape of a bra cup.

31. The method according to claim 1, wherein the curing forms a solid comprising flexible foam particles bonded together into a single piece.

32. The method according to claim 31, wherein the solid is in the shape of a hexahedron.

33. The method according to claim 31, wherein the solid is in the shape of a cylinder.

34. The method according to claim 31, further comprising shaping the solid into a bra cup.

35. The method according to claim 31, wherein the solid is in the shape of a bra cup.

36. The method according to claim 1, wherein the mold is shaped to form a bra cup with a first region and a second region having a thickness greater than the thickness of the first region.

37. The method according to claim 36, wherein the first region and the second region are formed in contact with each other.

38. The method according to claim 1, wherein the curing further forms a bra cup such that the first region has a density different than the second region.

39. The method according to claim 1, wherein the curing further forms a bra cup such that the first region has a density substantially equal to the second region.

40. A bra cup according to claim 1, wherein the first region is formed at a bust point area of the bra cup.

41. A bra cup according to claim 1, wherein the second region is formed in the peripheral area of the bra cup.

42. A bra cup according to claim 1, wherein a bra cup further comprises flexible foam particles bonded together into a single piece including first region and the second region.

43. A bra cup according to claim 1, wherein a bra cup further comprises flexible foam particles embedded within a solid foam including a first region and a second region.

44. The method according to claim 1, wherein the mold is preheated prior to step (e).

45. The method according to claim 1, wherein the mold is chilled during step (f).

46. The method according to claim 1, further comprising applying a layer of material to the mold prior to the placing.

47. The method according to claim 46, wherein the layer of material is bonded to a mixture during the curing.

48. A bra cup formed by bonding flexible foam particles into a solid structure comprising:
flexible foam particles; and
a reactive material.

49. A bra cup according to claim 48, wherein the flexible foam particles are flexible polyurethane foam particles.

50. A bra cup according to claim 48, wherein the reactive material is an adhesive.

51. A bra cup according to claim 48, wherein the reactive material is a hot melt polyurethane adhesive.

52. A bra cup according to claim 48, wherein the reactive material is a polyurethane prepolymer based adhesive.

53. A bra cup according to claim 48, wherein the reactive material is a low melt polyester material.

54. A bra cup according to claim 48, further comprising a layer of material attached to the outer part of a bra cup.

55. A bra cup according to claim 48, further comprising a layer of material attached to the inner part of a bra cup.

56. A bra cup formed by flexible foam particles embedded within a solid material comprising:
a first material; and
a second material comprising flexible foam particles.

57. A bra cup according to claim 56, wherein the second material is embedded within the first material.

58. A bra cup according to claim 56, wherein the first material is a polyurethane flexible foam.

59. A bra cup according to claim 56, wherein the flexible foam particles are flexible polyurethane foam particles.

60. A bra cup according to claim 56, wherein the first material and the second material form a substantially uniform structure.

61. A bra cup according to claim 56, wherein the first material and the second material are formed in contact with each other.

62. A bra cup according to claim 56, further comprising a layer of material attached to the outer part of a bra cup.

63. A bra cup according to claim 56, further comprising a layer of material attached to the inner part of a bra cup.
